(19) United States
(12) Patent Application Publication
(10) Pub. No.: US 2023/0027260 A1
(43) Pub. Date: Jan. 26, 2023

(54) ROBOT CONTROLLER AND EMERGENCY STOP METHOD OF ROBOT

(71) Applicant: NIDEC SANKYO CORPORATION, Nagano (JP)

(72) Inventor: Masashi HANAOKA, Nagano (JP)

(21) Appl. No.: 17/863,394

(22) Filed: Jul. 13, 2022

(30) Foreign Application Priority Data
Jul. 20, 2021 (JP) 2021-119888

(51) Int. Cl. B25J 9/16; B25J 9/12

(52) U.S. Cl. CPC B25J 9/1664; B25J 9/1653; B25J 9/1674; B25J 9/126

(57) ABSTRACT

A robot controller includes an all-axes control part collectively calculating position command values for a plurality of axes based on a predetermined trajectory of the robot, and motor drive control parts for each axis. The motor drive control part includes a stopping position command calculation part which calculates a stopping position command value for each axis with a motor coordinate system as a reference. The motor drive control part switches the position command value transmitted from the all-axes control part to the stopping position command value for each axis when an emergency stop signal is inputted and, after that, returns from the stopping position command value for each axis to the position command value transmitted from the all-axes control part. The all-axes control part starts calculation for outputting an emergency stop position command value for stopping the robot on the predetermined trajectory when the emergency stop signal is inputted.

### CROSS REFERENCE TO RELATED APPLICATION

The present invention claims priority under 35 U.S.C. § 119 to Japanese Application No. 2021-119888 filed Jul. 20, 2021, the entire content of which is incorporated herein by reference.

### TECHNICAL FIELD

At least an embodiment of the present invention may relate to control of a robot having a plurality of axes, and especially, relate to a robot controller which is capable of stopping a robot in an emergency while maintaining a coordinate of a hand tip in a predetermined trajectory and an emergency stop method of the robot.

### BACKGROUND

A robot controller which controls a robot having a plurality of axes and motors for each axis is provided with motor drive control parts each of which is provided for each motor to perform servo-control based on position command values to the motor. In order to move the robot along a specified trajectory, a plurality of axes provided in the robot is required to be moved simultaneously. Therefore, the robot controller is provided with an all-axes control part which collectively calculates and outputs position command values for each axis of the robot, and the position command values of each axis calculated in the all-axes control part are transmitted to a corresponding motor drive control part. Further, the robot is required to be emergency-stopped when the robot detects abnormality or when a command of an emergency stop is inputted from the outside during operation. When an emergency stop is to be performed, motor speeds of all axes are required to be 0 (zero) within a predetermined time period. Therefore, the robot controller is provided with an emergency stop signal input part into which an emergency stop signal instructing an emergency stop is to be inputted. When a robot is to be emergency-stopped, it is preferable that a position and a posture of the robot after emergency-stopped is located on a normal trajectory of the robot. Stopping at a position other than a normal trajectory, in other words, a situation that the robot is not maintained in a desired trajectory means that the robot is moved to an unexpected position and thus, a safety problem may occur and, in addition, it is difficult to control the robot when the robot is restored from the emergency stop.

As a control method in a robot controller when an emergency stop signal is inputted to make the robot emergency-stop, a method has been known in which an emergency stop signal is supplied to an all-axes control part, and the all-axes control part performs operation planning and inverse kinematics calculation of a hand tip based on a reference position of the hand tip when the emergency stop signal is received, and position command values of the respective axes are outputted so that the robot is stopped on a normal trajectory as near as possible. For example, Japanese Patent Laid-Open No. 2014-34108 (Patent Literature 1) discloses a technique that, when an emergency stop is to be performed, an all-axes control part plans an operation so that a hand is linearly moved in a moving direction of the hand while keeping a direction of the hand when the emergency stop signal is inputted and controls a motor for each axis. As a control method in a robot controller when a robot is to be emergency-stopped, a method has been known in which an emergency stop signal is supplied to respective motor drive control parts, and each of the motor drive control parts decelerates and stops each motor at acceleration for an emergency stop which is determined for each motor.

In a case that a robot is to be decelerated and stopped while maintaining a coordinate and a direction of a hand tip on a target trajectory when an emergency stop signal is inputted into a robot controller, a processing time for inverse kinematics calculation and operation planning is required, and a delay is also generated between an all-axes control part and motor drive control parts due to a transmission interval of position command values. Therefore, it is difficult to rapidly stop the robot after abnormality is detected and an emergency stop signal is generated. On the other hand, in a case that an emergency stop signal is inputted into respective motor drive control parts to decelerate and stop respective motors, a motor is controlled by speed command values calculated in an inside of the motor drive control part with a motor coordinate system of each axis as a reference and thus, each axis is independently stopped and it is not guaranteed that the robot is stopped on a normal trajectory.

### SUMMARY

In view of the problem described above, at least an embodiment of the present invention may advantageously provide a robot controller and an emergency stop method in which a robot is rapidly stopped while maintaining a coordinate and a direction of a hand tip on a target trajectory when the robot is to be emergency-stopped.

According to at least an embodiment of the present invention, there may be provided a robot controller which is configured to control a robot having a plurality of axes and driven by motors provided for each axis. The robot controller includes an all-axes control part which collectively calculates position command values for the plurality of the axes based on a predetermined trajectory of the robot, and motor drive control parts which are provided for each axis, and each of the motor drive control parts servo-controls the motor for each axis based on the position command value of a corresponding axis transmitted from the all-axes control part. The motor drive control part is provided with a stopping position command calculation part which calculates a stopping position command value for each axis for stopping a corresponding motor with a motor coordinate system as a reference. The motor drive control part switches the position command value used for servo-control from the position command value from the all-axes control part to the stopping position command value for each axis and servo-controls the corresponding motor when an emergency stop signal is inputted and, after that, the motor drive control part returns the position command value used for servo-control from the stopping position command value for each axis to the position command value from the all-axes control part to continue servo-control of the corresponding motor. The all-axes control part starts calculation for outputting an emergency stop position command value for stopping the robot on the predetermined trajectory when the emergency stop signal is inputted.

When a robot is to be emergency-stopped, an emergency stop position command value for stopping the robot on a predetermined trajectory, in other words, while maintaining a coordinate and a direction of a hand tip on a target trajectory is calculated in the all-axes control part after an emergency stop command is inputted and is transmitted to the motor drive control part. Therefore, a time for calculation processing until an emergency stop position command value starts to be outputted and a time required to transmit a position command value between the all-axes control part and the motor drive control part act as a delay time for stopping the robot. According to the robot controller in accordance with the present invention, when an emergency stop signal is inputted, the motor drive control part switches the position command value used for servo-control from the position command value from the all-axes control part to the stopping position command value for each axis and servo-controls the corresponding motor and, after that, the motor drive control part returns the position command value used for servo-control from the stopping position command value for each axis to the position command value from the all-axes control part to continue servo-control of the corresponding motor. Therefore, a delay time for stopping the robot can be shortened, and the robot can be rapidly stopped while maintaining a coordinate and a direction of a hand tip on a target trajectory.

In the robot controller in accordance with the present invention, it may be configured that, in a transition period in which the position command value used for servo-control is returned from the stopping position command value for each axis to the position command value from the all-axes control part, the motor drive control part calculates a position command value used for servo-control which is obtained by proportionally dividing the stopping position command value for each axis and the position command value from the all-axes control part while changing a proportional division rate. When the above-mentioned control is performed, a position command value used for servo-control can be returned to the position command value transmitted from the all-axes control part with a small amount of calculation while suppressing occurrence of vibration and an impact in the robot.

In the robot controller in accordance with the present invention, it may be configured that the all-axes control part is provided with an estimate value calculation part which estimates a movement of the robot by servo-controlling the motor for each axis through the stopping position command value for each axis, and a position command value calculation part which calculates a position command value for a correction operation which returns the robot to the predetermined trajectory based on an estimated result by the estimate value calculation part. The position command value calculation part calculates the emergency stop position command value following calculation of the position command value for the correction operation. According to this configuration, a position command value used for servo-control can be further smoothly returned to the position command value transmitted from the all-axes control part.

In the robot controller in accordance with the present invention, it may be configured that the position command value used for servo-control can be returned from the stopping position command value for each axis to the position command value of the all-axes control part based on a position-command switching command calculated by the all-axes control part. According to this configuration, the position command value used for servo-control can be returned to the position command value transmitted from the all-axes control part according to a timing when the all-axes control part is capable of outputting a position command value for a correction operation or an emergency stop position command value and thus, the robot can be further rapidly returned to the target trajectory.

In the robot controller in accordance with the present invention, the stopping position command value for each axis is, for example, a position command value for decelerating and stopping the motor according to acceleration or a deceleration time set for each motor. When the above-mentioned stopping position command value for each axis is used, for example, estimation of a movement of the robot can be easily performed when the motor for each axis is servo-controlled by the stopping position command value for each axis.

Further, according to at least an embodiment of the present invention, there may be provided an emergency stop method of a robot which includes a plurality of axes and is structured so that motors for each axis are servo-controlled based on position command values collectively calculated for the plurality of the axes by an all-axes control part so as to move along a predetermined trajectory. The emergency stop method includes, when an emergency stop signal is inputted, for each axis, switching the position command value used for servo-control from the position command value transmitted from the all-axes control part to a stopping position command value for each axis calculated with a motor coordinate system as a reference for stopping a corresponding motor and, after that, returning the position command value used for servo-control from the stopping position command value for each axis to the position command value transmitted from the all-axes control part and, when the emergency stop signal is inputted, starting calculation in the all-axes control part for outputting an emergency stop position command value for stopping the robot on the predetermined trajectory.

In the emergency stop method in accordance with the present invention, when an emergency stop signal is inputted, for each axis, the position command value used for servo-control is switches from the position command value transmitted from the all-axes control part to a stopping position command value for each axis and, after that, the position command value used for servo-control is returned from the stopping position command value for each axis to the position command value transmitted from the all-axes control part. Therefore, influence of a delay time from an input of an emergency stop signal to start of outputting an emergency stop position command value and influence of a delay time by a transmission interval of the position command value from the all-axes control part are reduced and the robot can be further rapidly stopped on the target trajectory.

In the emergency stop method in accordance with the present invention, it may be performed that, in a transition period in which the position command value used for servo-control is returned from the stopping position command value for each axis to the position command value transmitted from the all-axes control part, a position command value used for servo-control which is obtained by proportionally dividing the stopping position command value for each axis and the position command value transmitted from the all-axes control part while changing a proportional division rate. When the above-mentioned control is performed, the position command value used for servo-control can be returned to the position command value transmitted from the all-axes control part with a small amount of calculation while suppressing occurrence of vibration and an impact in the robot.

In the emergency stop method in accordance with the present invention, it may be performed that, when the emergency stop signal is inputted, a movement of the robot by servo-controlling the motor for each axis through the stopping position command value for each axis is estimated in the all-axes control part, and a position command value for a correction operation for returning the robot to the predetermined trajectory, i.e., a target trajectory is calculated based on the estimated movement of the robot. When a position command value for a correction operation calculated as described above is used, a position command value used for servo-control can be further smoothly returned to the position command value transmitted from the all-axes control part.

In the emergency stop method in accordance with the present invention, it may be performed that the position command value used for servo-control is returned from the stopping position command value for each axis to the position command value transmitted from the all-axes control part based on a position-command switching command calculated by the all-axes control part. When the above-mentioned position-command switching command is used, the position command value used for servo-control can be returned to the position command value transmitted from the all-axes control part according to a timing when the all-axes control part is capable of outputting a position command value for a correction operation or an emergency stop position command value and thus, the robot can be further rapidly returned to the target trajectory.

In the emergency stop method in accordance with the present invention, the stopping position command value for each axis is, for example, a position command value for decelerating and stopping the motor according to acceleration or a deceleration time set for each motor. When the above-mentioned stopping position command value for each axis is used, for example, estimation of a movement of the robot can be easily performed when a motor for each axis is servo-controlled by the stopping position command value for each axis.

### Effects of the Invention

According to the present invention, when the robot is to be emergency-stopped, the robot can be rapidly stopped while maintaining a coordinate and a direction of the hand tip on the target trajectory.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A and 1B are views showing an example of a structure of an articulated robot.

FIGS. 2A, 2B and 2C are explanatory plan views showing a movement of the robot in FIGS. 1A and 1B.

FIGS. 3A through 3H are explanatory views showing a position, angles, a speed and angular speeds of respective parts of a robot.

FIG. 4 is a block diagram showing an example of a configuration of a robot controller.

FIG. 5 is a block diagram showing a configuration of an all-axes control part.

FIG. 6 is a block diagram showing a configuration of a motor drive control part.

FIGS. 7A through 7F are explanatory views showing angles and angular speeds of respective parts of a robot at a time of an emergency stop.

FIGS. 8A and 8B are explanatory views showing a trajectory of a robot at a time of an emergency stop.

FIG. 9 is an explanatory timing diagram showing an emergency stop method in a first embodiment of the present invention.

FIG. 10 is a block diagram showing a configuration of a motor drive control part.

FIG. 11 is an explanatory timing diagram showing an emergency stop method in a second embodiment of the present invention.

FIG. 12 is an explanatory view showing changes of a position of a hand tip and its posture accompanied with an emergency stop.

FIGS. 13A through 13F are explanatory views showing positions, an angle, speeds and an angular speed of respective parts of a robot at a time of an emergency stop.

FIG. 14 is a block diagram showing a configuration of an all-axes control part.

FIG. 15 is a block diagram showing a configuration of a motor drive control part.

### DETAILED DESCRIPTION

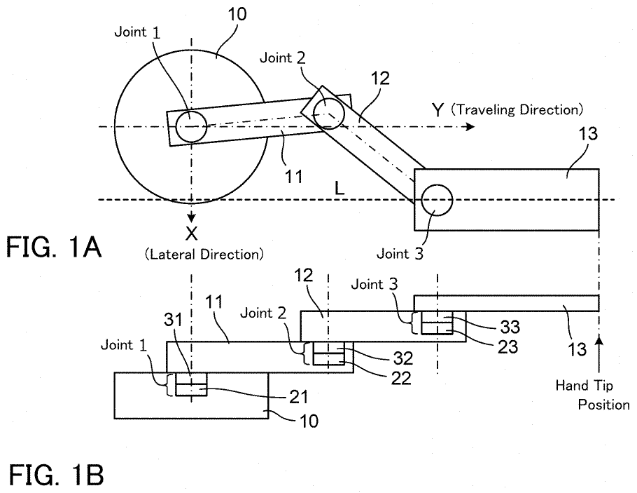

Embodiments of the present invention will be described below. A robot controller in accordance with an embodiment of the present invention is used for controlling a robot having a plurality of axes. However, in the following descriptions, a horizontal articulated robot having three joints as shown in FIGS. 1A and 1B is described as an object to be controlled by a robot controller. The present invention may be also applied to a robot controller which controls a robot other than a robot shown in FIGS. 1A and 1B.

FIGS. 1A and 1B are respectively a top plan view and a front view showing a horizontal articulated robot. A horizontal articulated robot shown in FIGS. 1A and 1B is structured so that one end of a link 11 is connected with a base 10 through a joint 1, one end of a link 12 is connected with the other end of the link 11 through a joint 2, and one end of a hand 13 is connected with the other end of the link 12 through a joint 3. The other end of the hand 13 corresponds to a hand tip position of the robot. All axes of the joints 1 through 3 are directed in a vertical direction. The joint 1 includes a motor 21 and a speed reducer 31 connected with the motor 21 and, when the motor 21 is driven, the link 11 is moved on a horizontal face. Similarly, the joint 2 includes a motor 22 and a speed reducer 32 and, when the motor 22 is driven, the link 12 is moved on a horizontal face. The joint 3 includes a motor 23 and a speed reducer 33 and, when the motor 23 is driven, the hand 13 is moved on a horizontal face. As shown in FIG. 1A, “X”-“Y” orthogonal coordinates are defined on a horizontal face with an axis position of the joint 1 as a center. This robot is driven and controlled so that the hand 13 is reciprocated along a “Y” direction (also referred to as a traveling direction) on a straight line “L” in the drawing while keeping a longitudinal direction of the hand 13 parallel to the “Y”-axis. The straight line “L” is a straight line extended in the “Y” direction and is a straight line indicating a target trajectory of a hand tip position of the robot. The straight line “L” is located at a position shifted from the axis of the joint 1 by a predetermined distance in the “X” direction (referred to as a lateral direction).

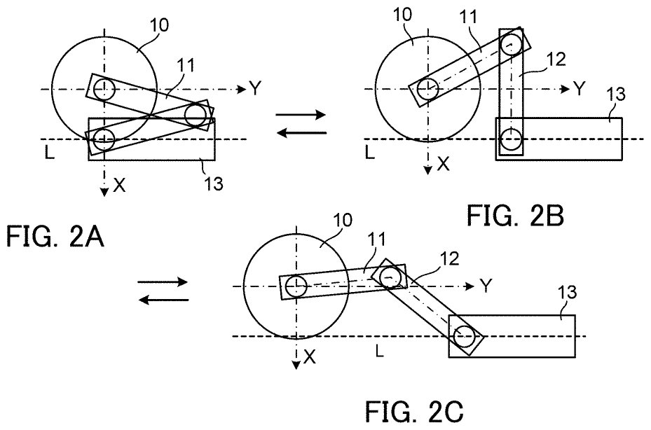

FIGS. 2A, 2B and 2C show how positions and postures of the links 11 and 12 and the hand 13 change when the robot shown in FIGS. 1A and 1B is operated on a normal trajectory. The robot is, as shown in FIGS. 2A, 2B and 2C, operated between a state that the links 11 and 12 and the hand 13 are folded in a “Z”-shape and a state that the links 11 and 12 and the hand 13 are extended. In a folded state shown in FIG. 2A, the joint 3 is located on a straight line which is extended in the “X” direction from the joint 1. When the links 11 and 12 and the hand 13 are to be changed from the folded state to the extended state, the link 11 is turned in a counterclockwise direction around the axis of the joint 1 to reach a state (FIG. 2B) that a longitudinal direction of the hand 13 and a longitudinal direction of the link 12 are perpendicular to each other. After that, the link 11 is turned in a clockwise direction to reach a state that the links 11 and 12 and the hand 13 are extended as shown in FIG. 2C. The hand 13 is moved in the “Y” direction so that a center line in its longitudinal direction is always located on the straight line “L”.

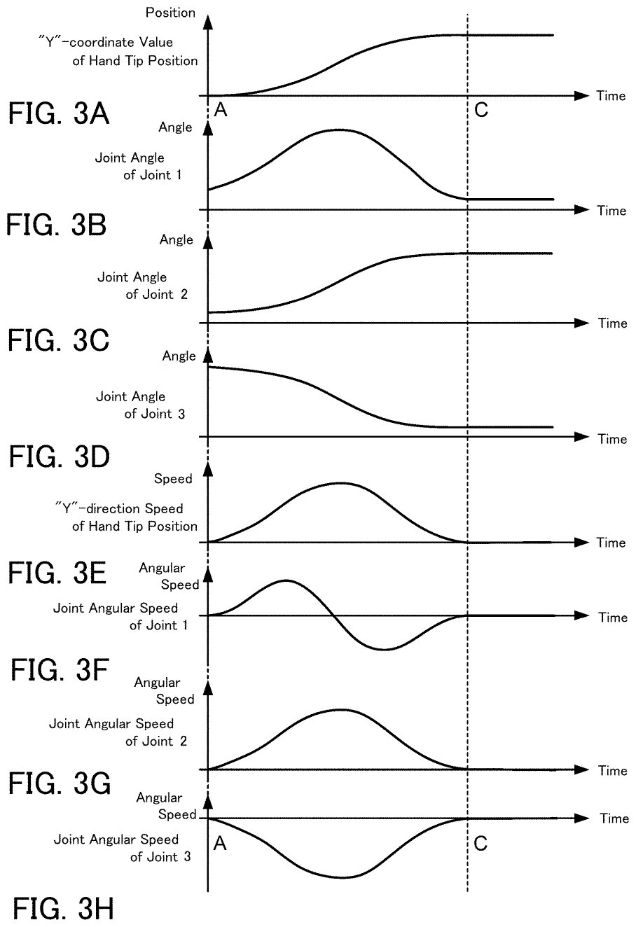

FIGS. 3A through 3H are graphs for explaining changes of a position, angles, a speed and angular speeds of respective parts of the robot when the robot is moved from a state in FIG. 2A to a state in FIG. 2C, and show a case that the robot in the state in FIG. 2A starts to move from the time point “A” and reaches the state in FIG. 2C at the time point “C” and, after that, the robot is stopped. FIG. 3A shows a “Y”-coordinate value of a position of a tip end of the hand 13, FIG. 3B shows a joint angle of the joint 1, FIG. 3C shows a joint angle of the joint 2, and FIG. 3D shows a joint angle of the joint 3. In addition, FIG. 3E shows a speed along the “Y” direction of the hand 13, FIG. 3F shows a joint angular speed of the joint 1, FIG. 3G shows a joint angular speed of the joint 2, and FIG. 3H shows a joint angular speed of the joint 3.

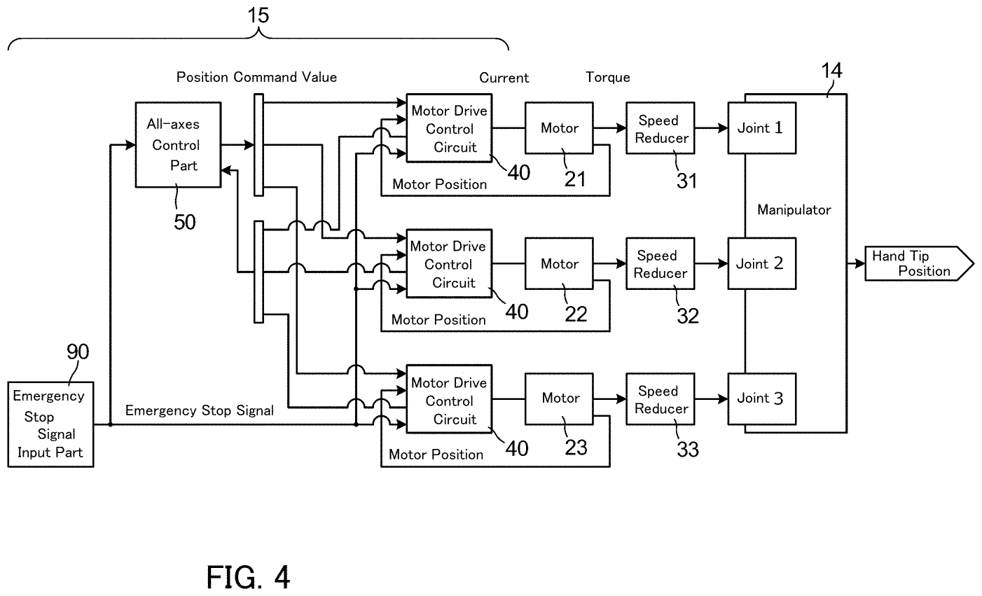

FIG. 4 is a block diagram showing a configuration of a robot controller 15 which controls the horizontal articulated robot shown in FIGS. 1A and 1B. In the robot, portions structured of the links 11 and 12 and the hand 13 are collectively referred to as a manipulator 14, and the manipulator 14 is moved by the joints 1 through 3 which are respectively driven by the motors 21 through 23 through the speed reducers 31 through 33. The robot controller 15 is provided with motor drive control parts 40 which are respectively provided for the motors 21 through 23 to servo-control corresponding motors by position command values for each motor, an all-axes control part 50 which collectively calculates position command values for the motors 21 through 23, and an emergency stop signal input part 90 into which an emergency stop signal for making the robot perform an emergency stop is inputted from the outside. Each of the motors 21 through 23 is provided with an encoder, and a motor position detected by the encoder is fed back to the motor drive control part 40 for servo-control. An emergency stop signal which is received by the emergency stop signal input part 90 is transmitted to each of the motor drive control parts 40 and the all-axes control part 50. Further, in order that the all-axes control part 50 recognizes states of the motor drive control parts 40, a signal indicating an emergency stop state in the motor drive control part 40 is transmitted from each of the motor drive control parts 40 to the all-axes control part 50.

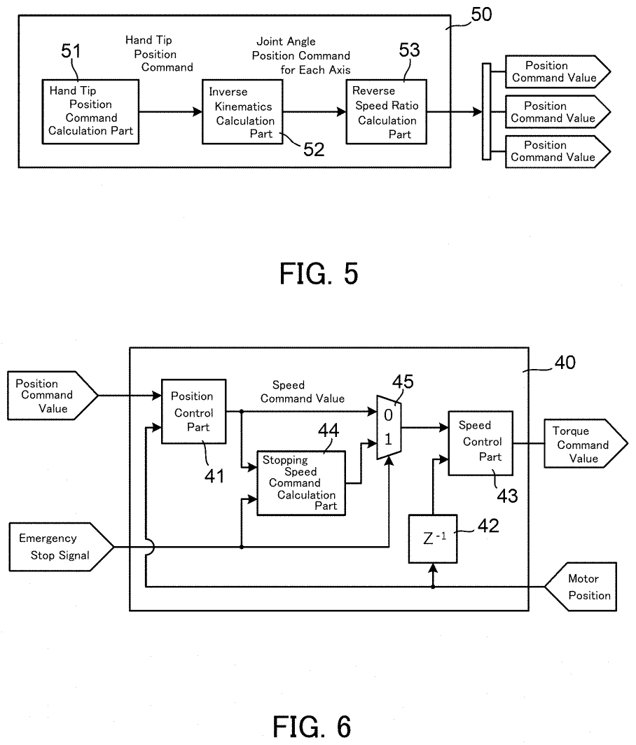

FIG. 5 is a block diagram showing a configuration of the all-axes control part 50. The all-axes control part 50 is provided with a hand tip position command calculation part 51 which calculates a hand tip position command, an inverse kinematics calculation part 52 which performs inverse kinematics calculation based on the hand position command to calculate a position command expressed by a joint angle (joint angle position command) of each axis, and a reverse speed ratio calculation part 43 which performs reverse speed ratio calculation based on the position command expressed by a joint angle of each axis to calculate a position command value for each of the motors 21 through 23.

Next, an emergency stop method of the robot shown in FIGS. 1A and 1B will be described below. Before an emergency stop method in accordance with the present invention is described, a conventional emergency stop method will be described below. As described above, the conventional emergency stop methods include a method in which a deceleration stop is performed while maintaining a coordinate and a direction of the hand on a target trajectory by inverse kinematics calculation, and a method in which a motor is decelerated and stopped by generating a command value in an inside of the motor drive control part with a motor coordinate system of each axis as a reference. In the method in which a deceleration stop is performed while maintaining a hand on a target trajectory, in a case that a robot is normally operated and a hand 13 is moved along a straight line “L” (see FIGS. 2A, 2B and 2C), when an emergency stop signal is inputted, the all-axes control part 50 is switched from a normal operation mode to an emergency deceleration stop mode and calculates position command values for motors 21 through 23 by inverse kinematics calculation for stopping the robot while making the robot move along a target trajectory. The calculated position command values are transmitted to the respective motor drive control parts 40. In this case, due to a processing time required to perform inverse kinematics calculation, or due to transmission intervals of communication between the all-axes control part 50 and the respective motor drive control parts 40, certain time is required for switching the position command values for a normal operation transmitted from the all-axes control part 50 to the respective motor drive control parts 40 to position command values for an emergency stop. For example, a delay of about several milliseconds is generated after the all-axes control part 50 has received an emergency stop signal until a deceleration operation starts in the respective motors 21 through 23.

On the other hand, in a case that a motor is decelerated and stopped by calculating a command value in an inside of the motor drive control part with a motor coordinate system of each axis as a reference, each of the motor drive control part 40 is configured to be capable of receiving an emergency stop signal. FIG. 6 shows a configuration of the motor drive control part 40 and, in this case, a speed command value is independently generated in the inside of the motor drive control part 40. As described above, a motor position is fed back to the motor drive control part 40 from an encoder attached to the motor. The motor drive control part 40 is provided with a position control part 41 which calculates a speed command value based on a position command value and a motor position, a speed calculation part 42 which calculates a motor speed from the motor position, a speed control part 43 which calculates a torque command value for the motor based on the speed command value and a motor speed inputted from the speed calculation part 42, a stopping speed command calculation part 44 which calculates a speed command value for braking for decelerating and stopping the motor based on the speed command value inputted from the position control part 41 when an emergency stop signal is inputted, and a selector 45 in which the speed command value outputted from the position control part 41 and a speed command value for braking which is calculated by the stopping speed command calculation part 44 are switched from each other depending on presence or absence of an emergency stop signal to input into the speed control part 43. A torque command value outputted from the speed control part 43 is converted into an electric current and the motor is driven by the converted electric current.

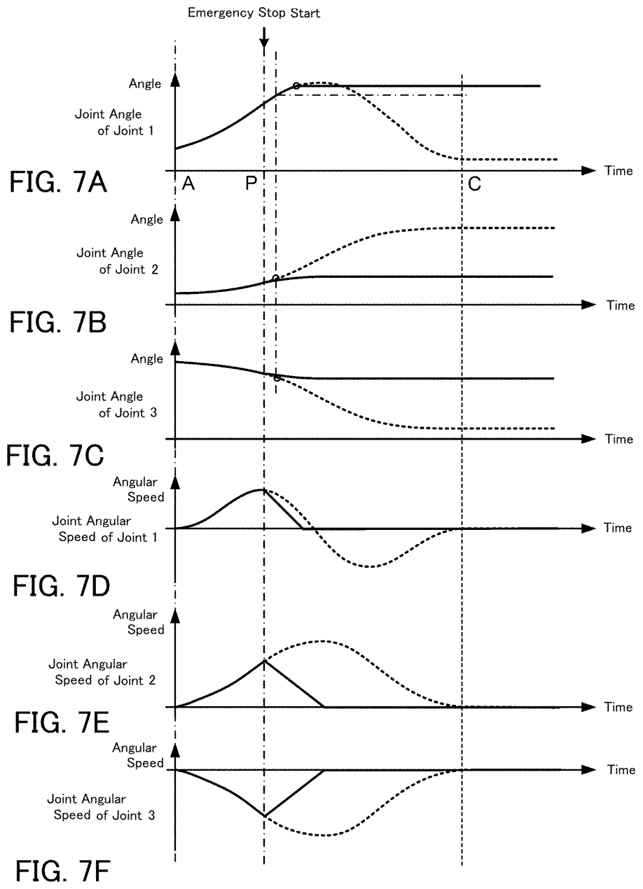

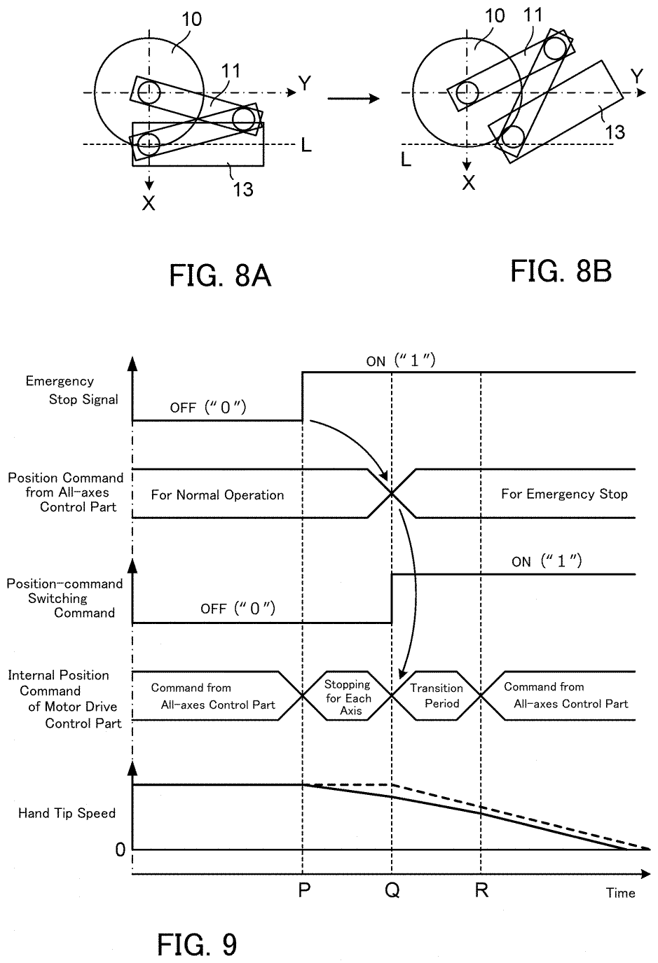

FIGS. 7A through 7F are graphs for explaining changes of angles and angular speeds of respective parts of the robot when an emergency stop operation is performed by using the motor drive control part 40 shown in FIG. 6. In this example, an emergency stop signal is inputted in the middle of movement of the robot in a normal operation shown in FIGS. 3A through 3H and an emergency stop operation is started, and the broken lines indicate joint angles and joint angular speeds in the normal operation shown in FIGS. 3A through 3H. FIG. 7A shows a joint angle of the joint 1, FIG. 7B shows a joint angle of the joint 2, FIG. 7C shows a joint angle of the joint 3, FIG. 7D shows a joint angular speed of the joint 1, FIG. 7E shows a joint angular speed of the joint 2, and FIG. 7F shows a joint angular speed of the joint 3. As shown by the graphs of the respective joint angular speeds in FIGS. 7D through 7F, when an emergency stop operation is started, each joint, i.e., each motor is decelerated at an acceleration set for each motor. As a result, the angles of the respective joints are changed as shown by the graphs in FIGS. 7A through 7C. The angles of the respective joints in this case are shifted from angles that the robot maintains a normal trajectory (straight line “L” shown in FIGS. 2A through 2C). FIGS. 8A and 8B are explanatory views showing the deviation from the normal trajectory. FIG. 8A shows the same state as the state shown in FIG. 2A. In a state that the robot is operating from this state to the state shown in FIG. 2C, when the robot is emergency-stopped, for example, the robot is stopped in a state shown in FIG. 8B. In the stopped state shown in FIG. 8B, a tip end position of the hand 13 of the robot is largely deviated from the straight line “L” which is an original trajectory, and a direction in a longitudinal direction of the hand 13 is largely shifted from a direction where the straight line “L” is extended.

### First Embodiment

As described above, in the conventional emergency stop methods, a delay occurs before the motor starts to decelerate, or a coordinate and a direction of the hand is not maintained on a target trajectory. In view of the problems described above, in an emergency stop method in accordance with a first embodiment of the present invention, the above-mentioned two emergency stop methods are combined with each other, in other words, a method in which a hand is decelerated and stopped by inverse kinematics calculation and a method in which a command value is generated in an inside of the motor drive control part with a motor coordinate system of each axis as a reference are combined with each other and thereby, while shortening a time until a motor is started to decelerate after an emergency stop signal is received, the robot is stopped in a state that a coordinate and a direction of a hand is maintained on a target trajectory. Specifically, each of the motor drive control parts 40 is configured to be capable of calculating a position command value for an emergency stop (stopping position command value for each axis) and, when an emergency stop signal is inputted, a position command value which is used in each of the motor drive control parts 40 for servo-control of a motor is switched from a position command value from the all-axes control part 50 to a stopping position command value for each axis to decelerate the motor. In parallel with this operation, when the emergency stop signal is inputted, the all-axes control part 50 starts calculation for decelerating and stopping the hand by inverse kinematics calculation and, when a predetermined time period has elapsed, each of the motor control drive parts 40 gradually switches from servo-control by the stopping position command value for each axis to servo-control which makes the hand decelerate and stop by the inverse kinematics calculation. Further, finally, the robot is stopped under control only by the position command value for deceleration stop of the hand by the inverse kinematics calculation. Start of switching from servo-control by the stopping position command value for each axis to servo-control by the position command value for decelerating the hand which is calculated by the inverse kinematics calculation is given by a position-command switching command. FIG. 9 shows an emergency stop operation in the first embodiment of the present invention.

In the timing diagram shown in FIG. 9, in an initial state, the robot is performing a normal operation and the hand 13 is moving at a predetermined speed, and both of an emergency stop signal and a position-command switching command are in “off” (“zero”) states. Position commands transmitted from the all-axes control part 50 to each of the motor drive control parts 40 are for a normal operation, and the motor drive control part 40 is performing servo-control for its motor based on the position command values from the all-axes control part 50. In this case, it is assumed that the emergency stop signal is switched from “off” to “on” (“1”) at a time “P”. At this time, a position-command switching command is still in an “off” state, and the position commands transmitted from the all-axes control part 50 to each of the motor drive control parts 40 are still for a normal operation. The all-axes control part 50 continues to output the position command values for a normal operation even when the emergency stop signal is inputted, but the all-axes control part 50 starts operation planning for decelerating the hand.

On the other hand, when the emergency stop signal is inputted into the motor drive control part 40 at the time “P”, the motor drive control part 40 switches the position command value used for servo-control of the motor from the all-axes control part 50 to a stopping position command value for each axis. As a result, the motor starts to decelerate and a speed of the hand tip position also starts to deteriorate. The stopping position command value for each axis is, for example, a position command value calculated for each motor with the motor coordinate system as a reference in order to decelerate and stop the motor according to acceleration or deceleration time which is set for each motor. After that, the position-command switching command is switched from “off” to “on” at a time “Q”. As a result, the all-axes control part 50 stops output of the position command value for a normal operation and starts output of a position command value for an emergency stop, in other words, for decelerating and stopping the hand while maintaining a target trajectory. It is conceivable that the position command value used in the motor drive control part 40 for servo-control is switched to the position command value for an emergency stop transmitted from the all-axes control part 50 at the time “Q”. However, in this case, the robot is unable to operate smoothly, and an excessive torque, vibration, an impact or the like may occur. In order to prevent the problem, according to at least an embodiment of the present invention, a period from the time “Q” to a time “R” is set to be a transition period, and the position command value is gradually switched within the transition period. For example, in the motor drive control part 40, when a position command value used for servo-control is defined as “Pc”, a position command value for an emergency stop which is outputted from the all-axes control part 50 is defined as “Pcik”, a stopping position command value for each axis generated in an inside of the motor drive control part 40 is defined as “Pcm”, and an elapsed time from the time “Q” is defined as “t” (t≥0 (zero)), the position command value is obtained by the following equation:

Pc=r(t)×Pcik+{1−r(t)}×Pcm (1).

In this expression, r(t) is a proportional division rate and, when a length of the transition period is set to be “T”,

in a case that “t≤T”, “r(t)=a×t”, and

in a case that “t>T”, “r(t)=1”.

The “a” is a parameter indicating a time change rate of a proportional division rate and is expressed as “a=1/T”. The speed of the hand position is continuing to decelerate also in the transition period. The length “T” of the transition period is determined depending on structure and the like of the robot.

When the time “R” has arrived and the transition period has finished, the position command value used for servo-control in the inside of the motor control drive part 40 is completely switched to the position command value for an emergency stop transmitted from the all-axes control part 50, the motor continues to decelerate, and the speed of the hand tip position also decelerates toward zero. The speed of the hand tip position is also shown in FIG. 9. In FIG. 9, the speed of the hand tip position shown by the broken line indicates a speed of the hand tip position when a deceleration stop of the hand is executed only by the inverse kinematics calculation. In a case that the hand is decelerated and stopped only by the inverse kinematics calculation, deceleration of the motor starts after calculation of inverse kinematics in the all-axes control part 50 has finished, and it is conceivable that the deceleration of the motor starts just before the time “Q”. However, according to the emergency stop method in accordance with an embodiment of the present invention described above, in comparison with a case that an emergency stop is performed only by deceleration stop while maintaining a trajectory of the hand in a desired value, start of deceleration of the motor becomes earlier from the time “Q” to the time “P”, and by that time period, a time until the hand of the robot has been completely stopped is also shortened.

A basic configuration of the robot controller which is used for executing the emergency stop method in this embodiment is similar to the robot controller 15 described with reference to FIG. 4, but an internal configuration of the motor drive control part 40 is different. As the all-axes control part 50, the configuration shown in FIG. 5 may be used. However, the all-axes control part 50 is also inputted from each of the motor drive control parts 40 with a signal indicating whether a position command value used for servo-control in the motor drive control part 40 is transmitted from the all-axes control part 50 or a stopping position command value for each axis generated in the inside of the motor drive control part 40 in addition to a signal indicating an emergency stop state.

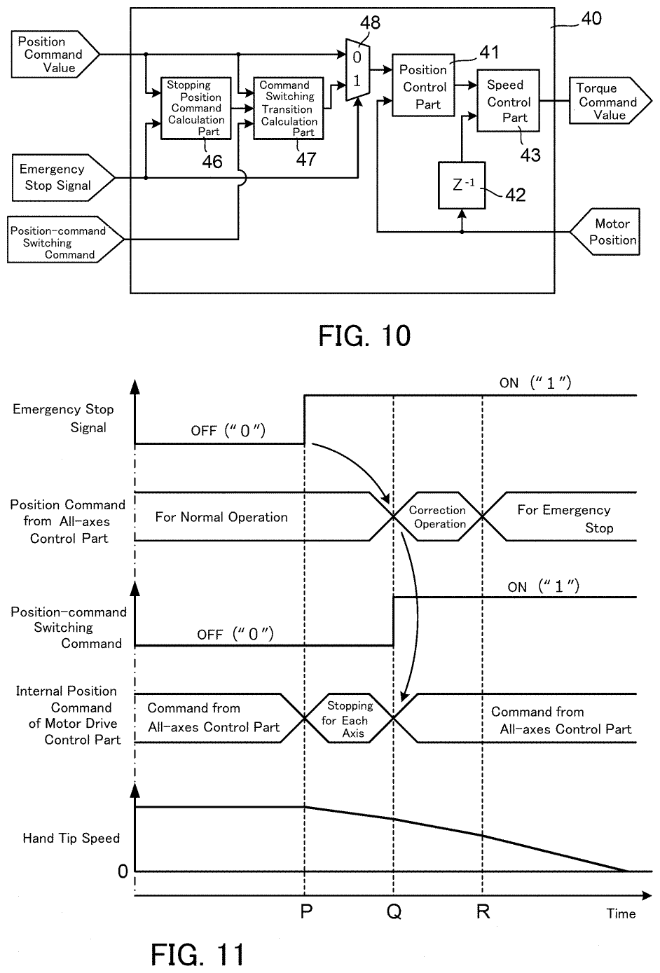

FIG. 10 shows a configuration of the motor drive control part 40 used in the first embodiment of the present invention. The motor drive control part 40 is provided with a position control part 41 which calculates a speed command value based on a position command value and a motor position, a speed calculation part 42 which calculates a motor speed from the motor position, a speed control part 43 which calculates a torque command value to the motor based on the speed command value and the motor speed inputted from the speed calculation part 42, a stopping position command calculation part 46 which is inputted with an emergency stop signal and calculates a stopping position command value for each axis based on a position command value from the all-axes control part 50, a command switching transition calculation part 47, and a selector 48 which switches a position command value from the all-axes control part 50 and a position command value obtained by calculation in the command switching transition calculation part 47 based on an emergency stop signal to input to the position control part 41. The command switching transition calculation part 47 outputs a stopping position command value for each axis outputted from the stopping position command calculation part 46 to the selector 48 before a position-command switching command is inputted and, when the position-command switching command is inputted, the command switching transition calculation part 47 outputs a result obtained by calculation according to the expression (1). The selector 48 selects a position command value from the all-axes control part 50 when an emergency stop signal is not inputted and, when the emergency stop signal is inputted, the selector 48 selects a position command value which is outputted from the command position transition calculation part 47. As a result, the motor drive control part 40 performs servo-control of the motor by using the position command value from the all-axes control part 50 until an emergency stop signal is inputted, and the motor drive control part 40 performs servo-control of the motor by using a stopping position command value for each axis after the emergency stop signal is inputted and until a position-command switching command is inputted. In addition, after the position-command switching command has been inputted, the motor drive control part 40 performs servo-control based on the expression (1) during the transition period. Especially, after the transition period has finished, the command switching transition calculation part 47 outputs the position command value transmitted from the all-axes control part 50 as it is and thus, the motor drive control part 40 performs servo-control of the motor by using the position command value for an emergency stop transmitted from the all-axes control part 50.

In this embodiment, the position-command switching command may be outputted by the all-axes control part 50 at a time when the position command value for an emergency stop is capable of being outputted in the all-axes control part 50, or may be outputted by the emergency stop signal input part 90 at a time when a predetermined time period has elapsed from an input of the emergency stop signal. In addition, instead of calculating a position-command switching command in the outside of the motor drive control part 40, a position-command switching command may be calculated in the inside of the motor drive control part 40 after a predetermined time has elapsed from a time when an emergency stop signal is inputted.

According to the emergency stop method in this embodiment described above, a robot can be stopped with simple calculation while shortening a time until the motor starts to decelerate after an emergency stop signal is received, and a coordinate and a direction of the hand tip are maintained on a target trajectory.

### Second Embodiment

Next, an emergency stop method in accordance with a second embodiment of the present invention will be described below. In the first embodiment described above, a transition period is provided and, in the transition period, the position command value from the all-axes control part 50 and the stopping internal position command are proportionally divided according to an elapsed time and thereby, switching from the stopping position command value for each axis to the position command value for an emergency stop transmitted from the all-axes control part 50 is performed smoothly. However, when correction calculation is performed in the all-axes control part 50 instead of performing proportional division calculation in the motor drive control part 40, further smooth switching can be realized from the stopping position command value for each axis to the position command value for an emergency stop transmitted from the all-axes control part 50. In the second embodiment, correction calculation is performed in the all-axes calculation part 50. FIG. 11 is a timing diagram for explaining an emergency stop method in accordance with a second embodiment of the present invention. In the timing diagram shown in FIG. 11, an operation before the time “P” is similar to that described with reference to FIG. 9.

In the timing diagram shown in FIG. 11, it is assumed that an emergency stop signal is switched from “off” (“0”) to “on” (“1”) at a time “P”. At this time, a position-command switching command is still in an “off” state, and position commands transmitted from the all-axes control part 50 to each of the motor drive control parts 40 are still for a normal operation. The all-axes control part 50 continues to output the position command values for a normal operation even when the emergency stop signal is inputted, but the all-axes control part 50 starts operation planning for deceleration stop maintaining a coordinate and a direction of the hand tip on a target trajectory. Especially, the all-axes control part 50 estimates a robot position when the motor drive control part 40 performs servo-control based on the stopping position command value for each axis and, based on the estimated result, the all-axes control part 50 starts calculation (correction calculation) for correction operation which corrects a position and a posture of the robot. When the emergency stop signal is inputted into the motor drive control part 40 at the time “P”, the motor drive control part 40 switches the position command value used for servo-control of the motor from the all-axes control part 50 to the stopping position command value for each axis. As a result, the motor starts to decelerate and a speed of the hand tip position also starts to deteriorate.

After that, the position-command switching command is switched from “off” to “on” at a time “Q”. As a result, the all-axes control part 50 stops output of the position command value for a normal operation and outputs a position command value of a correction operation in order to correct deviation from an original trajectory which is generated when the robot is controlled based on the stopping position command value for each axis. Next, at a time “R”, when the robot is returned to the original trajectory, i.e., a target trajectory, the all-axes control part 50 outputs a position command value for an emergency stop. When the position-command switching command is switched to “on”, the motor drive control part 40 switches a position command value used in its inside for servo-control from the stopping position command value for each axis to the position command value outputted from the all-axes control part 50. As a result, a speed of the hand tip position is decelerated similarly to the case shown in FIG. 9 and quickly reaches “0” (zero).

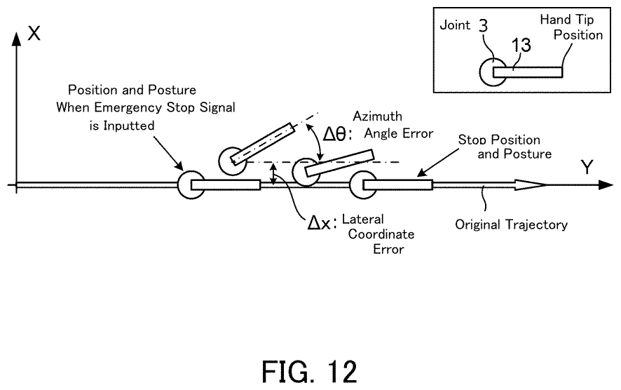

FIG. 12 is a view showing changes of a position and a posture of the hand 13 of the robot when an emergency stop is performed in the second embodiment of the present invention and shows how the hand 13 is moved on the “X-Y” plane. When an emergency stop signal is inputted and servo-control is started based on a stopping internal position command in each of the motor drive control parts 40, the position of the hand 13 is deviated from an original trajectory and a direction in a longitudinal direction of the hand 13 is also inclined with respect to the “Y” direction. Next, when servo control is started based on a position command value of a correction operation transmitted from the all-axes control part 50, a position and a posture of the hand 13 is corrected to be along an original trajectory, and successively, the hand 13 is stopped in a state that the position and the posture of the hand 13 is maintained on the original trajectory by the position command value for an emergency stop from the all-axes control part 50. In this embodiment, a deviation amount between a position of the joint 3 in the hand 13 and the original trajectory is set to be a lateral coordinate error “Ax”, and an angle between a longitudinal direction of the hand 13 and the “Y” direction is set to be an azimuth angle error “Δθ”.

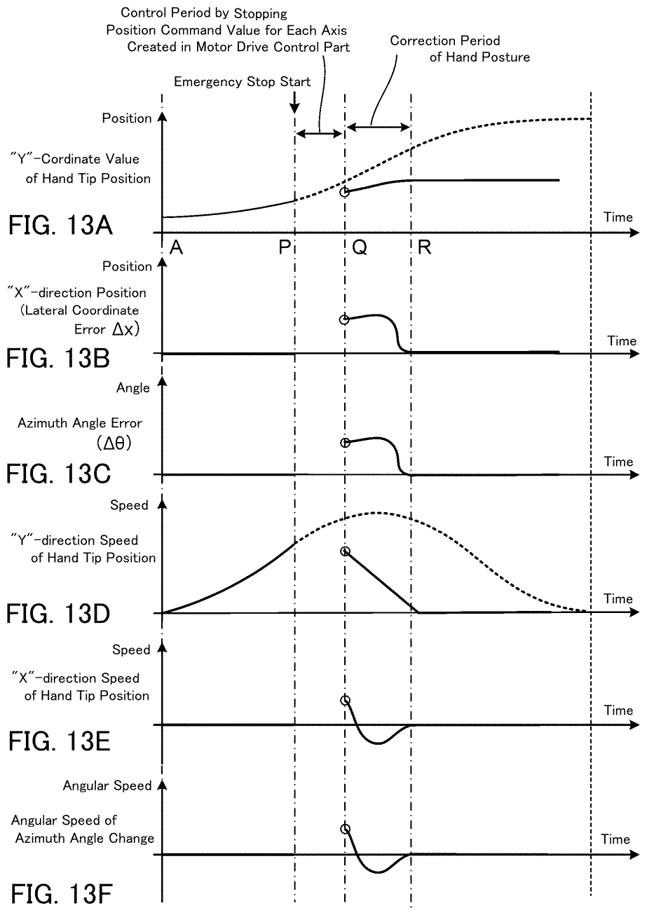

FIGS. 13A through 13F are graphs showing changes of positions, an angle, speeds and an angular speed of respective parts of the robot when an emergency stop operation of the robot has been performed in the second embodiment of the present invention. FIG. 13A shows a “Y”-coordinate value of the hand tip position, FIG. 13B shows an “X”-direction position of the joint 3, i.e., a lateral coordinate error “Δx”, FIG. 13C shows an azimuth angle error “Δθ”, FIG. 13D shows a “Y”-direction speed of the hand tip position, FIG. 13E shows an “X”-direction speed of the hand tip position, and FIG. 13F shows a temporal change of an azimuth error “Δθ”, i.e., an angular speed of an azimuth angle. A time period from a timing when an emergency stop signal is inputted (time “P”) to a timing when a position-command switching command is inputted (time “Q”) is a time period that each motor is servo-controlled based on the stopping position command value for each axis calculated in the motor drive control part 40 and, in FIGS. 13A through 13F, changes of positions, an angle, speeds and an angular speed are not shown during the period. The robot is moved along a predetermined trajectory until an emergency stop signal is inputted at the time “P”. When an emergency stop signal is inputted, each motor is servo-controlled based on the stopping position command value for each axis calculated in the motor drive control part 40 and thus, the robot deviates from the predetermined trajectory. A deviated amount is recognized by the lateral coordinate error “Δx” and the azimuth angle error “Δθ” at the time “Q”. During the time period from the time “Q” to the time “R”, each motor is servo-controlled based on the position command value of the correction operation outputted from the all-axes control part 50, and a posture of the hand and the like are corrected so that the robot returns to the original trajectory. At the time “Q”, the motor has already started deceleration through control by using the stopping position command value for each axis, and the position command value of the correction operation is planned to achieve a smooth correction operation with a coordinate and a speed of the hand tip at the time “Q” as initial values. As a result, the robot returns to the original trajectory at the time “R”. After that, each motor is controlled based on the position command value for an emergency stop which is used for decelerating and stopping while maintaining a coordinate and a direction of the hand tip on the target trajectory, and the robot finally stops on the target trajectory.

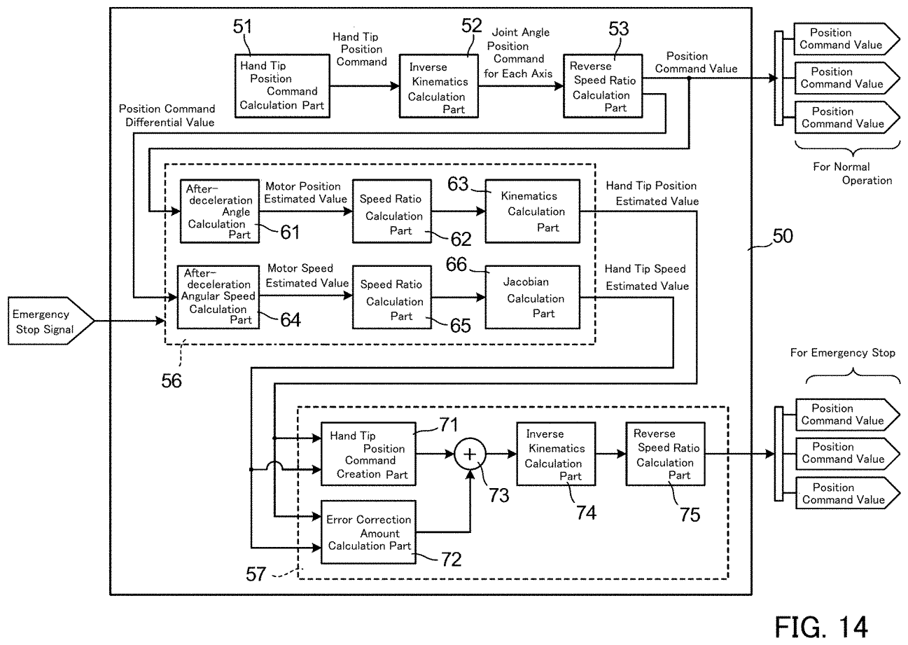

The robot controller which performs an emergency stop operation in accordance with the second embodiment of the present invention is, similarly to the first embodiment, provided with the all-axes control part 50 and the motor drive control part 40 for each motor. In the second embodiment, as described with reference to FIG. 12 and FIGS. 13A through 13F, the all-axes control part 50 requires to output the position command value for a correction operation at the time “Q”. On the other hand, the all-axes control part 50 requires some time before the all-axes control part 50 starts to output the position command (in other words, a position command for an emergency stop) for decelerating and stopping of the hand. Therefore, the all-axes control part 50 estimates a position and a speed of each motor at the time “Q” to estimate a coordinate and a speed of the hand tip at the time “Q” based on the results. FIG. 14 shows a configuration of the all-axes control part 50 used in this embodiment.

The all-axes control part 50 shown in FIG. 14 is, in addition to the configuration of the all-axes control part 50 shown in FIG. 5, provided with an estimate value calculation part 56 for estimating a position and a speed of the robot at the time “Q”, and a position command value calculation part 57 which calculates a position command value of a correction operation and a position command value for an emergency stop for decelerating and stopping while maintaining a coordinate and a direction of the hand tip on a target trajectory based on the estimated values provided in the estimate value calculation part 56. The reverse speed ratio calculation part 53 which outputs the position command value for a normal operation also outputs a position command differential value in addition to the position command value. An emergency stop signal is also inputted into the estimate value calculation part 56.

The estimate value calculation part 56 is provided with an after-deceleration angle calculation part 61 which takes a position command value outputted from the reverse speed ratio calculation part 53 at a time when an emergency stop signal is inputted and estimates a motor position after deceleration by the stopping position command value for each axis, a speed ratio calculation part 62 which performs speed ratio calculation based on a motor position estimated by the after-deceleration angle calculation part 61, and a kinematics calculation part 63 which performs kinematics calculation based on a calculation result of the speed ratio calculation part 62 to calculate a hand tip position estimated value. In addition, the estimate value calculation part 56 is provided with an after-deceleration angular speed calculation part 64 which takes the position command differential value outputted from the reverse speed ratio calculation part 53 at the time when the emergency stop signal is inputted and estimates a motor speed after deceleration by the stopping position command value for each axis, a speed ratio calculation part 65 which performs speed ratio calculation based on a motor speed estimated by the after-deceleration angular speed calculation part 61, and a Jacobian calculation part 66 which performs Jacobian calculation based on a calculation result by the speed ratio calculation part 62 to calculate a hand tip speed estimated value. In each of the motor drive control parts 40, when the motor is to be decelerated based on the stopping position command value for each axis, control for decelerating the motor is executed at acceleration (or deceleration time) set for each motor. The acceleration for deceleration in this case is predetermined and thus, the after-deceleration angle calculation part 61 and the after-deceleration angular speed calculation part 64 are respectively capable of estimating a position and a speed of each motor at the time “Q” based on the position command value and the position command differential value which are outputted from the reverse speed ratio calculation part 53 at the time when an emergency stop signal is inputted. Next, speed ratio calculation is performed on the estimated values of the motor position and the motor speed and, in addition, kinematics calculation and Jacobian calculation are performed to be capable of estimating the hand position and the hand speed. The hand tip position estimated value includes a “Y” direction coordinate of the hand tip position, an “X” direction coordinate of the hand tip position (or lateral coordinate error “Ax”), and an azimuth angle error “Δθ”. The hand tip speed estimated value includes a “Y” direction speed of the hand tip position, an “X” direction speed of the hand tip position, and a temporal change of an azimuth angle error “Δθ” (in other words, azimuth angle angular speed).

The position command value calculation part 57 is provided with a hand tip position command calculation part 71 which calculates a hand tip position command for deceleration based on a “Y” direction coordinate and a “Y” direction speed of the hand tip position obtained by the estimate value calculation part 56, an inverse kinematics calculation part 74 which performs inverse kinematics calculation on the hand tip position command calculated by the hand tip position command calculation part 71, and a reverse speed ratio calculation part 75 which performs reverse speed ratio calculation with respect to a calculation result of the inverse kinematics calculation part 74 to output a position command value. In a case that a hand tip position command is calculated based on only a coordinate and a speed in the “Y” direction, deviation from a trajectory of the robot cannot be corrected. Therefore, the position command value calculation part 57 is further provided with an error correction amount calculation part 72 which calculates an error correction amount based on an “X” direction coordinate of the hand position, an azimuth angle error “Δθ”, an “X” direction speed and an azimuth angular speed of the hand position, and an addition part 73 which adds the error correction amount to the hand position command calculated by the hand tip position command calculation part 71. The hand tip position command to which the error correction amount is added in the addition part 73 is performed with inverse kinematics calculation in the inverse kinematics calculation part 74. When the position command value calculation part 57 described above is used, a position command value of a correction operation can be calculated in addition to a position command value for an emergency stop for decelerating and stopping while maintaining a trajectory of the hand tip in a desired value.

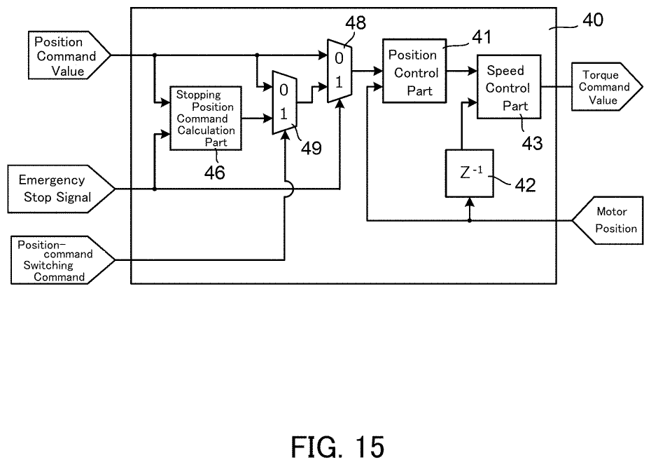

FIG. 15 shows a configuration of the motor drive control part 40 which is capable of using in the second embodiment of the present invention. The motor drive control part 40 is provided with a position control part 41 which calculates a speed command value based on a position command value and a motor position, a speed calculation part 42 which calculates a motor speed from the motor position, a speed control part 43 which calculates a torque command value for the motor based on the speed command value and the motor speed inputted from the speed calculation part 42, and a stopping position command calculation part 46 which is inputted with an emergency stop signal and calculates a stopping position command value for each axis based on the position command value from the all-axes control part 50. In addition, the motor drive control part 40 is provided with selectors 48 and 49 for switching a position command value inputted into the position control part 41. The selector 48 switches between the position command value from the all-axes control part 50 and the position command value outputted from the selector 49 depending on an emergency stop signal and inputs into the position control part 41. The selector 49 switches between the position command value from the all-axes control part 50 and the stopping position command value for each axis calculated by the stopping position command calculation part 46 depending on a position-command switching command and outputs one of them. As the selectors 48 and 49 are provided, the stopping position command value for each axis is inputted to the position control part 41 during a time period until the position-command switching command is inputted after an emergency stop signal has been inputted, and during other time periods, the position command value from the all-axes control part 50 is inputted to the position control part 41.

According to the emergency stop method in accordance with the second embodiment of the present invention as described above, although calculation processing in the all-axes control part 50 is complicated in comparison with the first embodiment, the robot can be further smoothly emergency-stopped on a target trajectory.

The emergency stop methods described above are embodiments in which the emergency stop methods are applied to a three-axes horizontal articulated robot. However, a robot to which the present invention may be applied is not limited to the robot described above and may be applied to a robot other than a horizontal articulated robot. Commonly, in a robot having many axes, it is often difficult to rapidly stop the robot while maintaining a coordinate and a direction of a hand on a target trajectory. However, according to the embodiments of the present invention, such a robot can be rapidly stopped while maintaining a coordinate and a direction of a hand on a target trajectory.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A robot controller configured to control a robot which comprises a plurality of axes and is driven by motors provided for each axis, the robot controller comprising:
an all-axes control part which collectively calculates position command values for the plurality of the axes based on a predetermined trajectory of the robot; and
motor drive control parts which are provided for each axis, each of the motor drive control parts servo-controlling the motor for each axis based on the position command value of a corresponding axis transmitted from the all-axes control part;
wherein the motor drive control part comprises a stopping position command calculation part which calculates a stopping position command value for each axis for stopping a corresponding motor with a motor coordinate system as a reference;
wherein the motor drive control part switches the position command value used for servo-control from the position command value transmitted from the all-axes control part to the stopping position command value for each axis and servo-controls the corresponding motor when an emergency stop signal is inputted and, after that, the motor drive control part returns the position command value used for servo-control from the stopping position command value for each axis to the position command value transmitted from the all-axes control part to continue servo-control of the corresponding motor; and
wherein the all-axes control part starts calculation for outputting an emergency stop position command value for stopping the robot on the predetermined trajectory when the emergency stop signal is inputted.

2. The robot controller according to claim 1, wherein in a transition period in which the position command value used for servo-control is returned from the stopping position command value for each axis to the position command value transmitted from the all-axes control part, the motor drive control part calculates a position command value used for servo-control which is obtained by proportionally dividing the stopping position command value for each axis and the position command value transmitted from the all-axes control part while changing a proportional division rate.

3. The robot controller according to claim 1, wherein
the all-axes control part comprises:
an estimate value calculation part which estimates a movement of the robot by servo-controlling the motor for each axis through the stopping position command value for each axis; and
a position command value calculation part which calculates a position command value for a correction operation which returns the robot to the predetermined trajectory based on an estimated result by the estimate value calculation part, and
the position command value calculation part calculates the emergency stop position command value following calculation of the position command value for the correction operation.

4. The robot controller according to claim 1, wherein the motor drive control part returns the position command value used for servo-control from the stopping position command value for each axis to the position command value transmitted from the all-axes control part based on a position-command switching command calculated by the all-axes control part.

5. The robot controller according to claim 1, wherein the stopping position command value for each axis is a position command value for decelerating and stopping the motor according to acceleration or a deceleration time set for each motor.

6. An emergency stop method of a robot which includes a plurality of axes and is structured so that motors for each axis are servo-controlled based on position command values collectively calculated for the plurality of the axes by an all-axes control part and that the robot is moved along a predetermined trajectory, the emergency stop method comprising:
when an emergency stop signal is inputted, for each axis, switching the position command value used for servo-control from the position command value transmitted from the all-axes control part to a stopping position command value for each axis calculated with a motor coordinate system as a reference for stopping a corresponding motor;
after that, returning the position command value used for servo-control from the stopping position command value for each axis to the position command value transmitted from the all-axes control part; and
when the emergency stop signal is inputted, starting calculation in the all-axes control part for outputting an emergency stop position command value for stopping the robot on the predetermined trajectory.

7. The emergency stop method according to claim 6, further comprising, in a transition period in which the position command value used for servo-control is returned from the stopping position command value for each axis to the position command value transmitted from the all-axes control part, calculating a position command value used for servo-control which is obtained by proportionally dividing the stopping position command value for each axis and the position command value transmitted from the all-axes control part while changing a proportional division rate.

8. The emergency stop method according to claim 6, further comprising:
when the emergency stop signal is inputted, estimating a movement of the robot by servo-controlling the motor for each axis through the stopping position command value for each axis in the all-axes control part; and
calculating a position command value for a correction operation for returning the robot to the predetermined trajectory based on estimated movement of the robot.

9. The emergency stop method according to claim 6, further comprising returning the position command value used for servo-control from the stopping position command value for each axis to the position command value transmitted from the all-axes control part based on a position-command switching command calculated by the all-axes control part.

10. The emergency stop method according to claim 6, wherein the stopping position command value for each axis is a position command value for decelerating and stopping the motor according to acceleration or a deceleration time set for each motor.
